(19) United States
(12) Patent Application Publication
(10) Pub. No.: US 2010/0117496 A1
(43) Pub. Date: May 13, 2010

(54) COUNTER MERCHANDISER THAT IS EXPANDABLE, ADJUSTABLE, STACKABLE AND LIGHTABLE

(75) Inventors: Timothy CLARKE, Wallingford, CT (US); Steve LANCOR, West Hartford, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: C & L MARKETING, LLC, Wallingford, CT (US)

(21) Appl. No.: 12/615,809

(22) Filed: Nov. 10, 2009

Related U.S. Application Data
(60) Provisional application No. 61/198,783, filed on Nov. 10, 2008.

(51) Int. Cl. A47F 9/00; A47F 1/14; A47F 7/00; G09F 13/04

(52) U.S. Cl. 312/140.1; 211/59.2; 211/85.8; 40/564

(57) ABSTRACT

A merchandising shelf unit is provided that when fully expanded is about 30″ wide by about 44¾″ high. The width can be adjusted to compress down to about 18″. It is designed so that another unit can be stacked on top of each other using stacking pins to secure the two units. Adjustable shelves allow for different heights, within the unit, depending on products being displayed. An optional light accessory system that can be secured underneath the shelves will allow for enhanced product presentation. The merchandising shelf unit is fully attachable to a counter, as well as being portable, and the merchandising shelf unit is made of a welded steel frame, acrylic sides and doors, and injection molded clear shelves. An adjustable front door panel can be installed to close in the merchandising shelf unit and can be secured with the installation of a lockset. This door unit can be hid away in the space between the acrylic side panels and welded steel frame. A flat front surface on the shelves will allow for the use of point-of-sale materials.

### CROSS-REFERENCE TO RELATED APPLICATIONS

This application claims benefit to provisional patent application Ser. No. 61/198,783, filed 10 Nov. 2008, which is hereby incorporated by reference in its entirety.

### BACKGROUND OF THE INVENTION

1. Field of Invention

The present invention provides an expandable, adjustable, stackable and lightable counter merchandiser, known as “The EASL.”

2. Brief Description of Related Art

A typical package store or retailer is filled with hundreds of different types and kind of alcoholic products, including liquor like single or multi-malt scotch, light or dark rum, whiskey, plain or flavored vodka, gin; red wines like cabernet sauvignon, merlot, chianti, pinot noir; white wines like sauvignon blanc, chardonnay, pinot grigio; cordials like brandy; beers; as well as many other different type and kinds of alcoholic products. Each product also typically includes many different brands and come from all over the world.

In a world of hundreds of different types and kind of alcoholic products, products get lost and may need to be re-discovered again. For example, products may typically be displayed on shelves in the retailer and many times remain in the same place for a long period of time, and can get lost in the marketplace to consumers. In addition, products fall out of trend in the marketplace.

Alternatively, product also become trendy, e.g., vodkas, and cry out for a place to be displayed in a highly visibility way in a retailer.

In view of this, there is a need in the industry to provide a retail or a distributor of a product with a new and exciting way to market products so as to bring the products to the immediate attention of the consumer in a high profile and vibrant way.

### SUMMARY OF THE INVENTION

The present provides a new and unique modular merchandiser for marketing a product, including an alcoholic product. The modular merchandiser features a merchandiser and one or more marketing lightbox. The merchandiser is configured with at least one shelf to display the product. The one or more marketing lightbox is configured to couple to the merchandiser, configured to receive a marketing board having a translucent plastic photochemical receptive substrate that is produced in a darkroom for receiving a graphic image through a digital printing process containing an advertising message to market the product being displayed on the merchandiser, having a rigid transparent part or diffuser panel for providing support to the translucent plastic photochemical receptive substrate containing the message, and configured with lights to provide backlit lighting through the marketing board so as to provide a backlit marketing message related to the alcoholic product.

The modular merchandiser according to the present invention provides a new way to market a product so as to bring the product to the immediate attention of consumers in a high profile and vibrant way.

The merchandiser may take the form of an expandable, adjustable, stackable and lightable merchandising shelf unit that when fully expanded is about 30″ wide by about 44¾″ high. The width can be adjusted to compress down to about 18″. It is designed so that another unit can be stacked on top of each other using stacking pins to secure the two units. Adjustable shelves allow for different heights, within the unit, depending on products being displayed. An optional light accessory system that can be secured underneath the shelves will allow for enhanced product presentation. The merchandising shelf unit is fully attachable to a counter, as well as being portable, and the merchandising shelf unit is made of a welded steel frame, acrylic sides and doors, and injection molded clear shelves. An adjustable front door panel can be installed to close in the merchandising shelf unit and can be secured with the installation of a lockset. This door unit can be hid away in the space between the acrylic side panels and welded steel frame. A flat front surface on the shelves will allow for the use of point-of-sale materials.

A framed side unit that has a back-lit fluorescent lighting system that comes in three different widths, e.g. 6″, 12″, and 18″ or a framed top unit that has a back-lit fluorescent system is about 18″ wide. These message boards are attachable to the EASL Merchandiser and work cooperatively together.

Some advantages of the EASL merchandiser design include the following:

The EASL Merchandiser can serve as a back bar unit for distilled spirits replacing the inefficient and antiquated bar rails;

The EASL Merchandiser can attach to shelf sections in liquor stores for the purpose of displaying and securing “high mark” spirit brands;

The EASL Merchandiser can be used for displaying and securing assorted 50 ml spirit brands in liquor stores;

The EASL Merchandiser can provide a secured lobby display in restaurants, including providing an angled and lit display for wine brands as people enter the restaurant; and/or

The EASL Merchandiser can secure and display distilled spirits on the back bar of hotel lobby bars, including, due to security reasons, the EASL Merchandiser may eliminate a hotel's need from having to take down the bar set up at the close of business.

### BRIEF DESCRIPTION OF THE DRAWING

The following is a brief description of that shown in the attached drawings, as follows:

FIG. 1 is a perspective view of a modular merchandiser for marketing an alcoholic product according to some embodiments of the present invention.

FIG. 2, including FIGS. 2A, 2B, 2C, 2D and 2E, shows various views of a complete assembly of the EASL merchandiser with doors according to some embodiments of the present invention, including adjustable steel framing, acrylic side panels, door panels that can be stored in side panels, and a locking system to secure the unit, where FIG. 2A is an exploded view of the EASL merchandiser, where FIG. 2B is an assembled view of the EASL merchandiser in FIG. 2A, where FIG. 2C is a front view of the EASL merchandiser in FIG. 2B, where FIG. 2D is a side view of the EASL merchandiser, and where FIG. 2E is a bottom view of the EASL merchandiser in FIG. 2B.

FIG. 3, including FIGS. 3A, 3B, 3C and 3D, shows various views of a left and right steel side frame that have tabs to permanently mount to a surface and multiple shelf mounting locations, where FIGS. 3A and 3B show the left and right steel side frame, where FIG. 3C is a side view of the right steel side frame in FIG. 3B, and where FIG. 3D is a bottom view of the right steel side frame in FIG. 3B.

FIG. 4, including FIGS. 4A, 4B, 4C; 4D, 4E, 4F, 4G, 4H, 4I, 4J, 4K, 4L, and 4M, shows various views of a shelf support, including a left side support, a joiner tube and a right side support, where the Left and Right sides have multiple holes for width adjustability, where the Joiner Tube adds additional support in center, where the shelf supports bolts to side frame shown in FIG. 3, and where on the left side of FIG. 4, the shelf support is shown in three different expanded positions in FIGS. 4J, 4K and 4M, where FIG. 4A is a view of the left side support, where FIG. 4B is a side view of the left side support in FIG. 4A, where FIG. 4C is an end view of the left side support in FIG. 4A when viewed from left-to-right on the page, where 4D is a view of the right side support, where FIG. 4E is a side view of the right side support in FIG. 4D, where FIG. 4F is an end view of the right side support in FIG. 4D when viewed from right-to-left on the page, where FIG. 4J is a view of a shelf support when expanded out to a full length, where FIG. 4K is a view of a shelf support when expanded out to an intermediate length, where FIG. 4L is a cross-sectional view of the shelf support when expanded out to the intermediate length in FIG. 4K along A-A, and where FIG. 4M is a view of a shelf support when expanded out to a short length.

FIG. 5, including FIGS. 5A, 5B, 5C, and 5D, shows various views of side panels that attach to the steel side frame shown in FIG. 3 and allow attachment of add-ons such as graphic panels or light boxes, where FIG. 5A is a perspective view a side panel, where FIG. 5B is a side view the side panel in FIG. 5A, where FIG. 5C is a side view the side panel in FIG. 5B when view from bottom-to-top on the page, and where FIG. 5D is an end view the side panel in FIG. 5A when view from bottom-to-top on the page.

FIG. 6, including FIGS. 6A, 6B, . . . , 6G, 6H, shows various views of both a left shelf that snaps onto shelf supports shown in FIG. 4, has the capability to hold an optional lighting unit and interlocks with right side shelving, as well as a right shelf that snaps onto shelf supports shown in FIG. 4, has the capability to hold an optional lighting unit and interlocks with left side shelving, where FIG. 6A is a perspective view a left shelf, where FIG. 6B is a top view the left shelf in FIG. 6A, where FIG. 6C is a side view the left shelf in FIG. 6B when view from bottom-to-top on the page, and where FIG. 6D is an end view the left shelf in FIG. 6A when view from bottom-to-top on the page, where FIG. 6E is a perspective view a right shelf, where FIG. 6F is a top view the right shelf in FIG. 6E, where FIG. 6G is a side view the right shelf in FIG. 6F when view from bottom-to-top on the page, and where FIG. 6H is an end view the right shelf in FIG. 6E when view from bottom-to-top on the page.

FIG. 7, including FIGS. 7A, 7B, 7C, and 7D, shows various views of a door bracket that supports a folding door mechanism, where FIG. 7A is a perspective view of a door bracket, where FIG. 7B is a side view of the door bracket in FIG. 7A, where FIG. 7C is a top down view of the door bracket in FIG. 7A, and where FIG. 7D is a bottom up view of the door bracket in FIG. 7A.

FIG. 8 shows a view of a door panel spacer that supports the door mechanism.

FIG. 9, including FIGS. 9A and 9B, shows door panels that are non-opaque to show product, locks for security and folds and tucks away in side panels.

FIG. 10, including FIGS. 10A, 10B, and 10C, shows various views of a fixed back panel that allows for a non-opaque window in the back of unit for product visibility, where FIG. 10A shows a fixed back panel, where FIG. 10B shows a side view of the fixed back panel in FIG. 10A, and where FIG. 100 shows an end view of the fixed back panel in FIG. 10A.

FIG. 11, including FIGS. 11A, 11B, and 110, shows various views of a moveable back panel that allows for non-opaque window in back of unit for product visibility, where FIG. 11A shows a movable back panel, where FIG. 11B shows a side view of the movable back panel in FIG. 11A, and where FIG. 11C shows an end view of the movable back panel in FIG. 11A.

FIG. 12, including FIGS. 12A and 12B, shows views of back panels that are non-opaque to allow product to be seen from rear of unit.

FIG. 13, including FIGS. 13A, 13B, 13C, and 13D, shows various views of a small marketing panel that can have illuminating front panel, allows for side graphics, and attaches to either side of unit, where FIG. 13A is a perspective view of a marketing panel, where FIG. 13B is an exploded view of the marketing panel in FIG. 13A, where FIG. 13C is a side view of the marketing panel in FIG. 13A, and where FIG. 13D is a back view of the marketing panel in FIG. 13A.

FIG. 14, including FIGS. 14A, 14B, 14C, and 14D, shows various views of a large marketing panel that can have illuminating front panel, allows for side graphics and attaches to either side of unit, where FIG. 14A is a perspective view of a marketing panel, where FIG. 14B is an exploded view of the marketing panel in FIG. 14A, where FIG. 14C is a side view of the marketing panel in FIG. 14A, and where FIG. 14D is a back view of the marketing panel in FIG. 14A.

FIG. 15, including FIGS. 15A, 15B, 15C, and 15D, shows various views of a medium marketing panel that can have illuminating front panel, allows for side graphics and attaches to either side of unit, where FIG. 15A is a perspective view of a marketing panel, where FIG. 15B is an exploded view of the marketing panel in FIG. 15A, where FIG. 15C is a side view of the marketing panel in FIG. 15A, and where FIG. 15D is a back view of the marketing panel in FIG. 15A.

FIG. 16, including FIGS. 16A, 16B, 16C, and 16D, shows various views of a header marketing panel that can have illuminating front panel, allows for side graphics and attaches to top side of unit, where FIG. 16A is a perspective view of a marketing panel, where FIG. 16B is an exploded view of the marketing panel in FIG. 16A, where FIG. 16C is a side view of the marketing panel in FIG. 16A, and where FIG. 16D is a back view of the marketing panel in FIG. 16A.

FIG. 17 shows an exploded perspective view of an alternative embodiment of the merchandiser according to some embodiments of the present invention.

FIG. 18 shows a perspective view of an embodiment of the cart according to some embodiments of the present invention.

FIG. 19 shows an exploded view of the cart shown in FIG. 18.

FIG. 20 shows an alternative embodiment of a header lightbox according to some embodiments of the present invention.

FIG. 21 shows an exploded view of the header lightbox shown in FIG. 20.

FIG. 22 shows an alternative embodiment of a marketing lightbox according to some embodiments of the present invention.

FIG. 23 shows an exploded view of the marketing lightbox shown in FIG. 22.

### DETAILED DESCRIPTION OF THE INVENTION

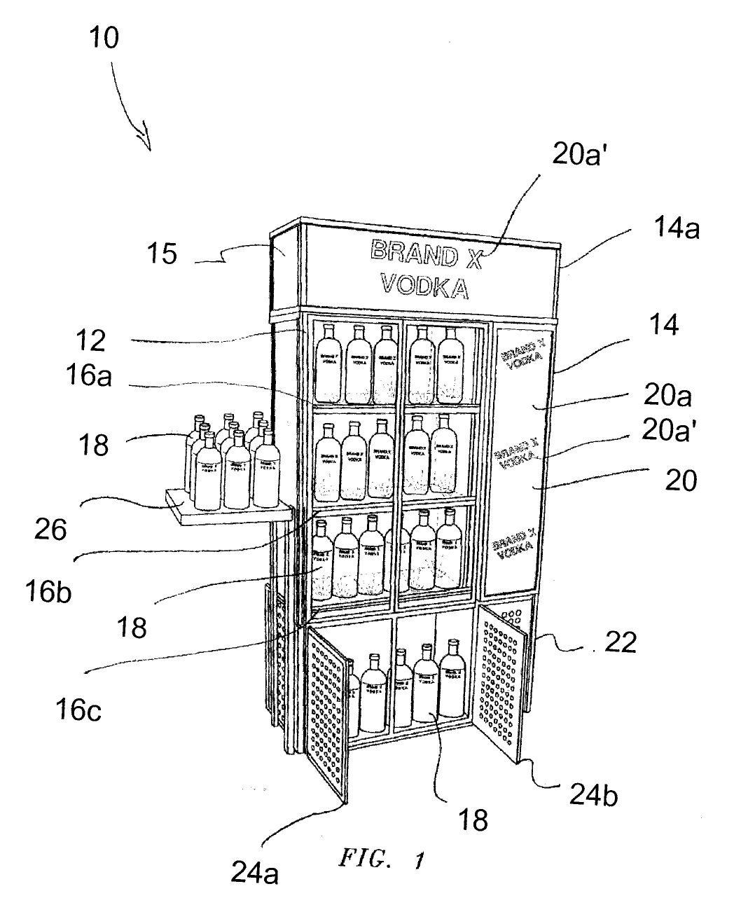

### FIG. 1: The Modular Merchandiser 10

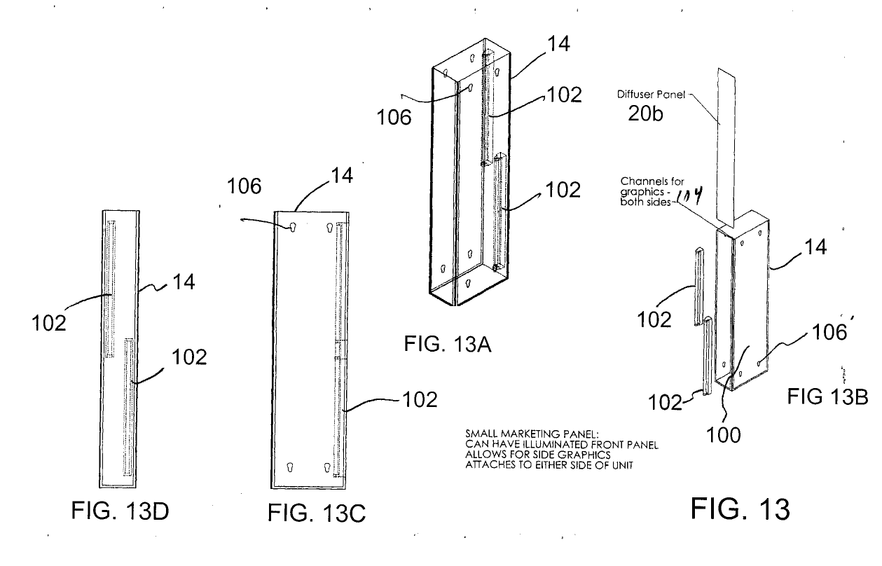

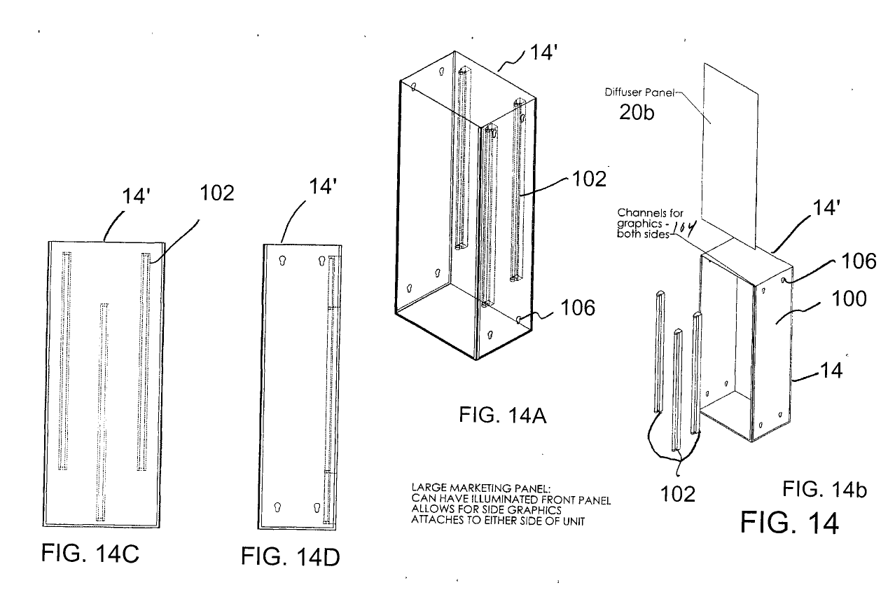

FIG. 1 shows a modular merchandiser generally indicated as 10 for marketing an alcoholic product according to some embodiments of the present invention. The modular merchandiser 10 features a merchandiser 12 and one or more marketing lightbox 14. The merchandiser 12 is configured with at least one shelf 16a, 16b, 16c to display a product 18, e.g. an alcohol product as shown. The one or more marketing lightbox 14 is configured to couple to the merchandiser 12, configured to receive a marketing board 20 having a translucent plastic photochemical receptive substrate 20a that is typically produced in a darkroom for receiving a graphic image through a digital printing process containing an advertising message 20a to market the product 18 being displayed on the merchandiser 12, having a rigid transparent part or diffuser panel 20b (see FIGS. 13b, 14b) for providing support to the translucent plastic photochemical receptive substrate containing the advertising message 20a′, and configured with lights to provide backlit lighting through the marketing board 20 so as to provide a backlit marketing message related to the product 18.

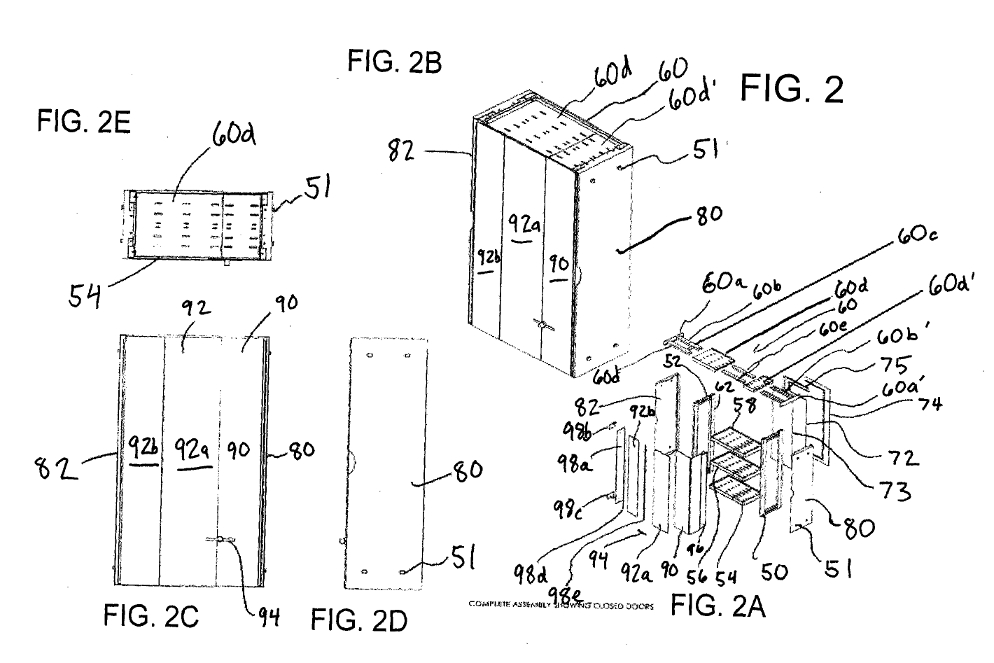

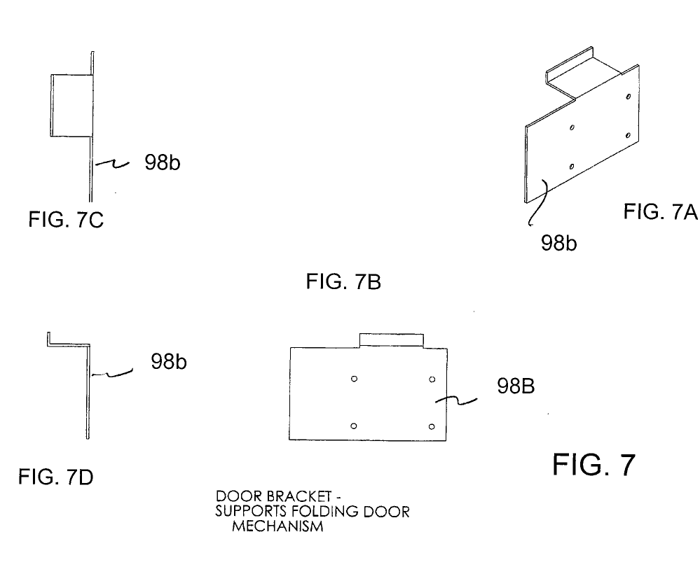

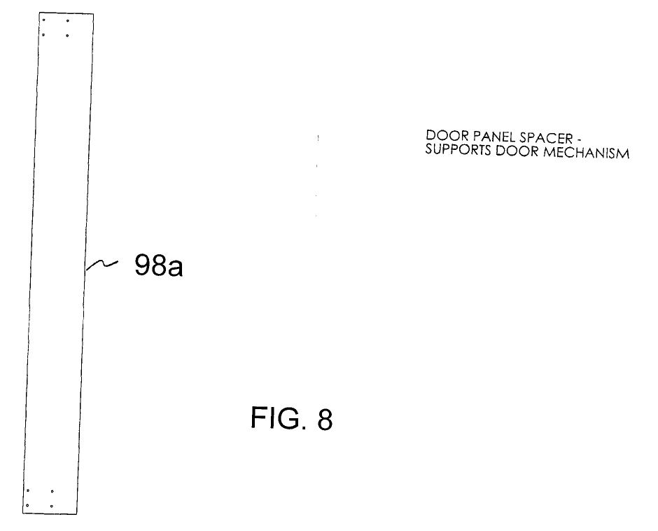

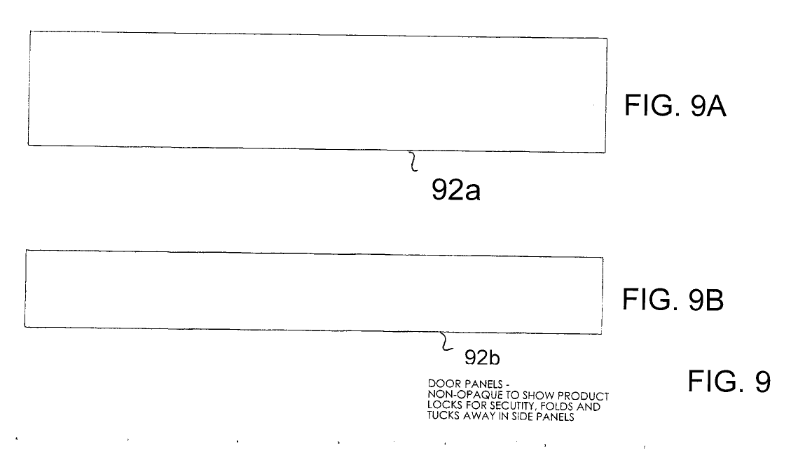

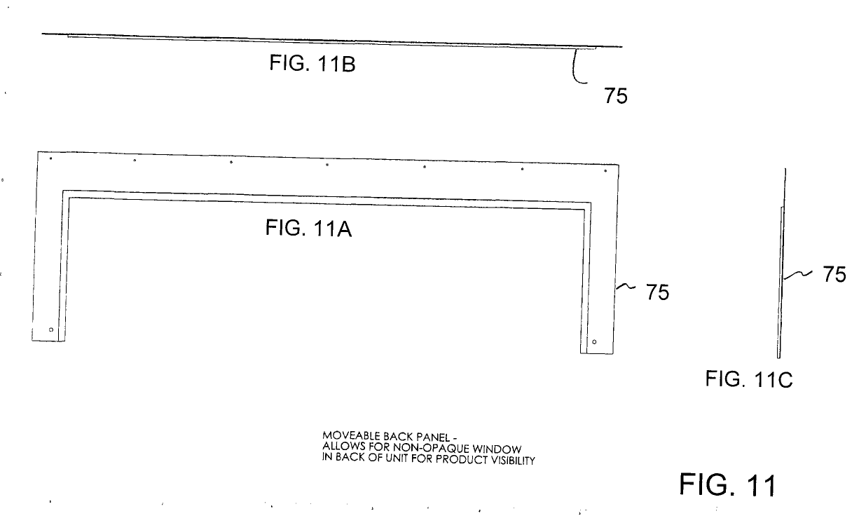

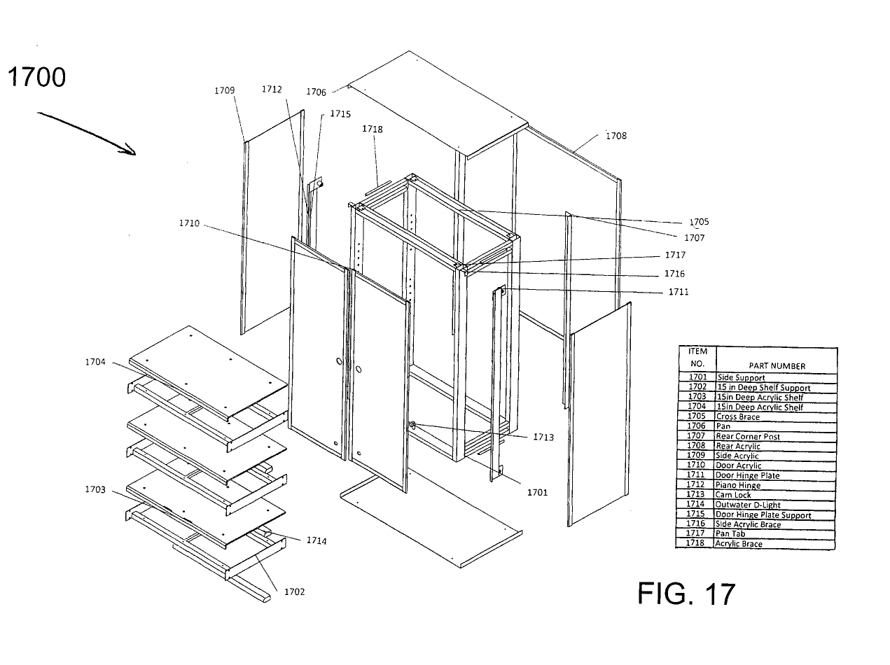

The merchandiser 12 is also known herein as the EASL, which is an expandable, adjustable, stackable and lightable counter merchandiser shown and described herein in greater detail in relation to FIGS. 2-12. The merchandiser 12 may also take the form of a stackable and lightable counter merchandiser shown and described herein in greater detail in relation to FIG. 17 that is not configured to expand and contract consistent with that described below.

The one or more marketing lightbox 14 is dimensioned to be adapted to and compliment the merchandiser 12. In FIG. 1, the marketing lightbox 14 is dimensioned to be substantially similar in height and depth as the merchandiser 12 so as to provide a neat modular merchandizing look and feel. As shown in FIG. 1, the one or more marketing lightbox 14 may include a second marketing lightbox 14a in the form of a headboard for also providing a similar backlit marketing message related to the alcoholic product. In this case, the second marketing lightbox 14a is dimensioned to be adapted to and compliment the merchandiser 12 and the marketing lightbox 14. In FIG. 1, the second marketing lightbox 14 is dimensioned to be substantially similar in length as the combined length of the merchandiser 12 and the marketing lightbox 14, as well as having a complimentary depth as the merchandiser 12 and the marketing lightbox 14, again so as to provide a neat modular merchandizing look and feel. Each marketing lightbox 14, 14a may also be configured to have marketing boards 20 on more than one side. For example, as shown the marketing lightbox 14a is shown to have a side 15 that may include a marketing board with a marketing message, as well.

The one or more marketing lightbox 14 take advantage of a unique technology known as Duratran (graphic), which is a translucent plastic photo chemical receptive substrate that is produced chemically in a dark room. There is an emulsion that is on the material that makes it sensitive to transferring an image to the substrate through a digital printing process. The material is a milky (in appearance) translucent plastic that is produced off of a roll and cut to size afterwards. After production the printed material is covered with a thin piece of clear acrylic to protect it when in position in the light box, and the image is lit up from the rear of the Duratran.

The modular merchandiser 10 has been quickly embraced as an exciting new merchandizing tool. The modular merchandiser 10 can be used to offer distributors the opportunity to feature product in a highly visible way in highly trafficked areas by consumers in a retail store. Flexible business arrangements can be made available, for example, where the distributor commissions one or more marketing boards for advertising its product, and lease the modular merchandiser 10 for a time certain. The retailer or a third party can easily configure the marketing board in the one or more lightbox 14 in the modular merchandiser 10 and display the associated product.

The scope of the invention is not intended to be limited to displaying and marketing alcoholic products. For example, embodiments are envisioned in which other types or kind of products may be displayed and marketing using the present invention, including hair salon-related products like shampoos, conditioners, or cosmetics, etc.

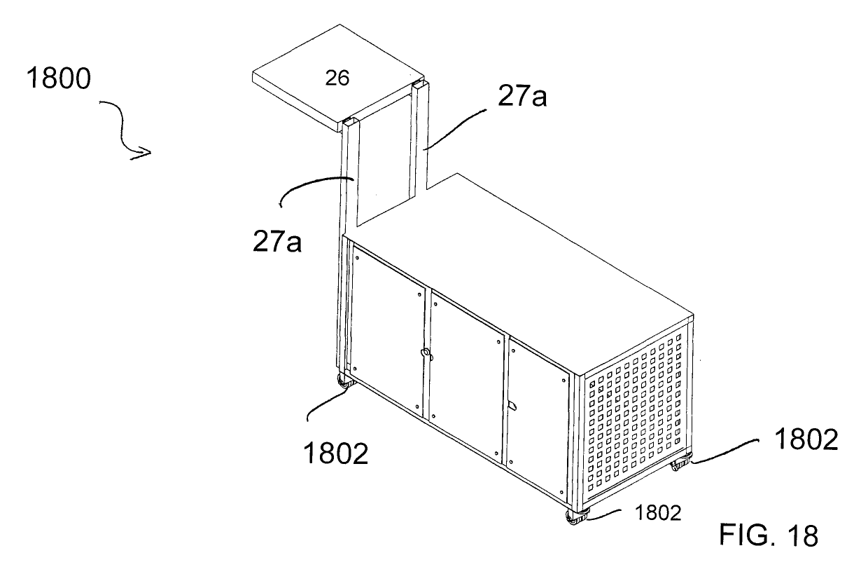

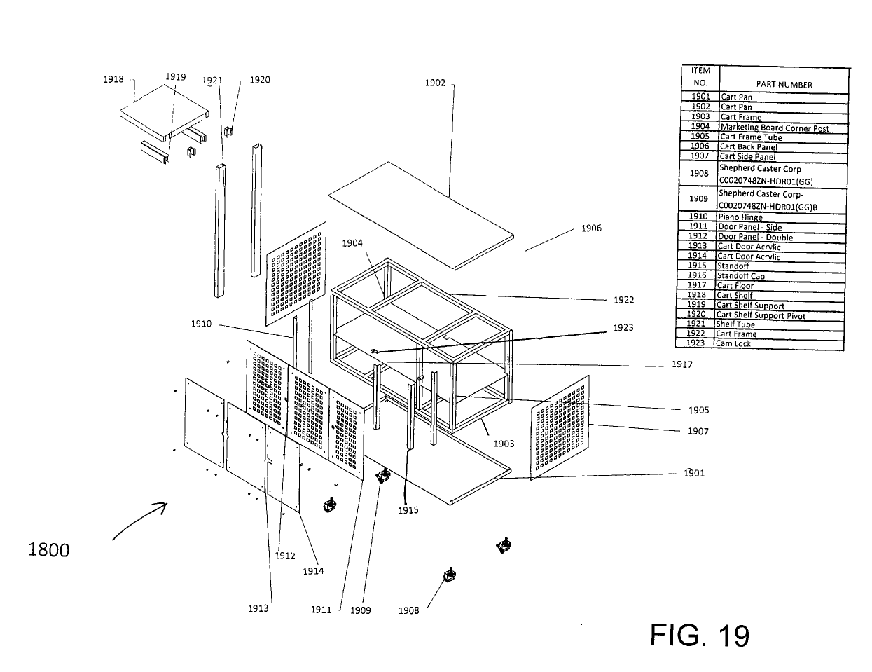

The modular merchandiser 10 may also include a cart 22 configured to support the merchandiser 10 and the one or more marketing lightbox 14. As shown, the cart 22 may be configured with panels or doors 24a, 24b that allow the product 18 to be stored away and later access when needed. The cart 22 may also be configured with wheel so as to enable it to roll for increasing the ease of moving and arranging the modular merchandiser 10, e.g., in the retail store. The cart 22 may also be configured with a tasting tray 26 for supporting the alcoholic product 18 and glassware, etc. for tasting. The reader is also referred to FIGS. 18 and 19 where the cart is shown without the merchandiser on top thereof.

### FIGS. 2-12: The EASL

The merchandiser 12 is the form of the EASL is shown in relation to FIGS. 2-12.

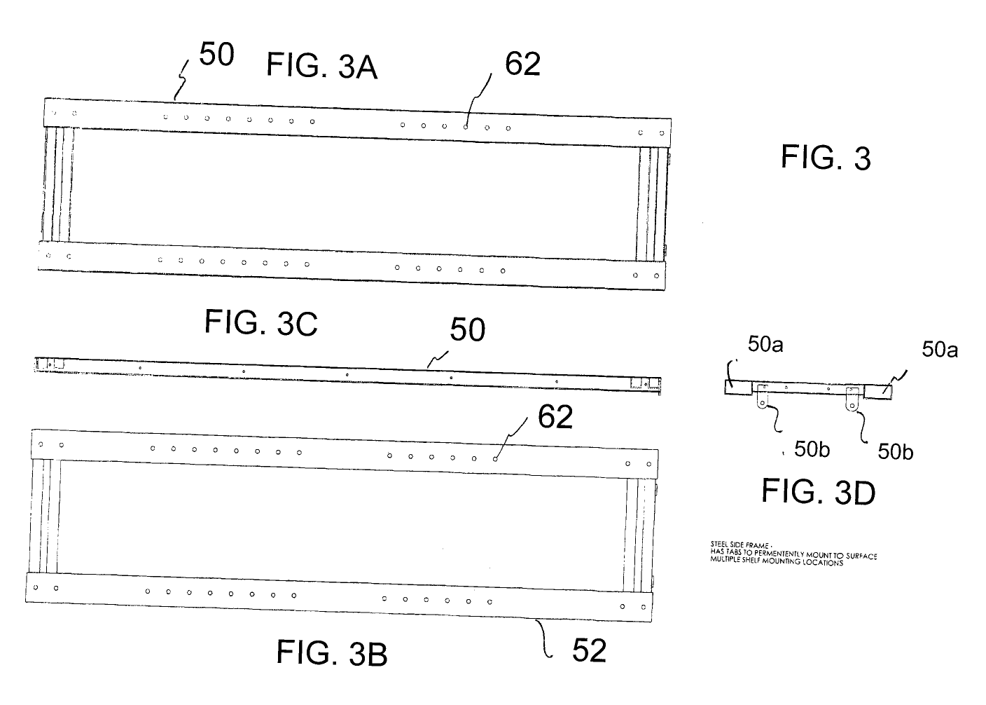

The EASL 12 has rigid metal side framing parts 50, 52, which are also shown in FIG. 3. Each rigid metal side framing part 50, 52 has multiple front and rear holes 62 configured for providing multiple shelf mounting locations.

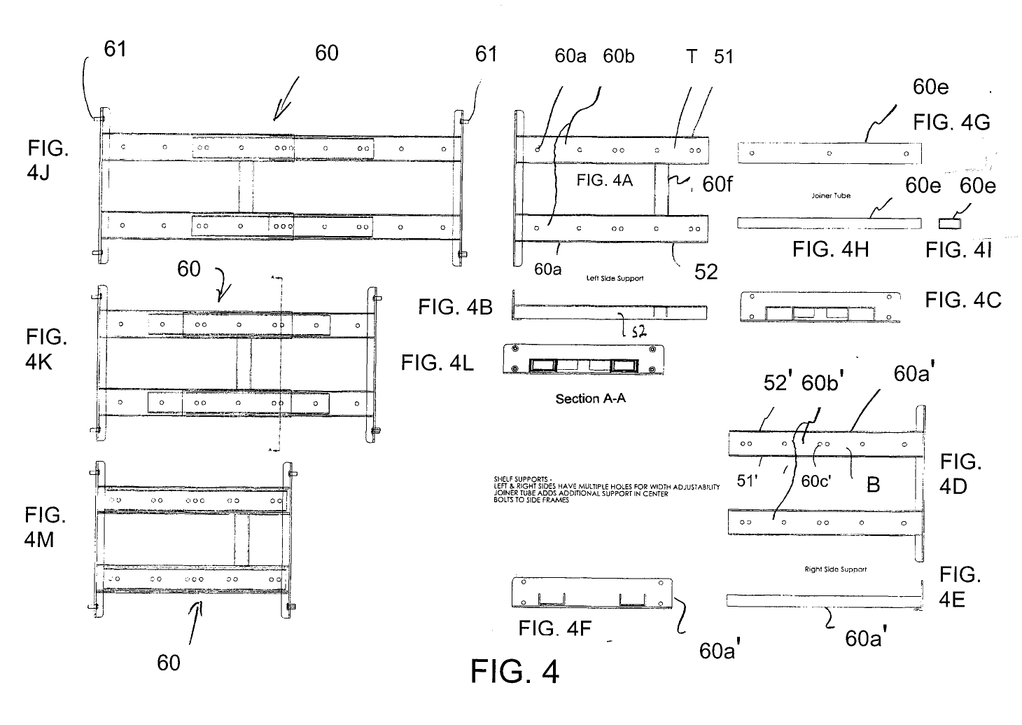

The EASL 12 has at least three adjustable shelf 54, 56, 58, 60 coupled between the rigid metal side framing parts 50, 52 so as to form shelves, including at least a top shelf 60, a bottom shelf 54 and at least one intermediate shelf 56, 58, which are also shown in FIG. 4. Each shelf 54, 56, 58, 60 has a shelf support 60a, 60a′ with a shelf mounting member 61 (see FIG. 4) configured to couple to a set of the multiple front and rear holes 60 of the rigid metal side framing parts 50, 52 for mounting the shelf support between the rigid metal side framing parts 50, 52. Each shelf support 60a. 60a′ has shelf legs 60b, 60b′ with multiple holes 60c, 60c′ configured for providing width adjustment; each shelf support 60a, 60a′ including a shelf leg 60b, 60b′ having an elongated rectangular shape configured with a top surface T and two side surfaces S1, S2 so as to form a hollow underneath portion; each shelf support 60a, 60a′ including a corresponding shelf leg 60b′ having a corresponding elongated rectangular shape configured with a bottom surface B and two corresponding side surfaces S1′, S2′ and dimensioned to slide within the hollow underneath portion of the shelf leg 60b for providing the width adjustment by aligning corresponding multiple holes 60c, 60c′ of shelf supports 60a, 60a′ and securing the corresponding multiple holes 60c, 60c′ with fasteners. The multiple holes 60c, 60c′ of the shelf legs 60b, 60b′ are configured for providing width adjustment at predetermined widths of about 18 inches, 24 inches, 30 inches or 36 inches. This can be very helpful when using the ESAL as a stand alone unit as a merchandiser for arranging on a countertop, behind a cash register space of a retailer, behind a bar for displaying the product, or in a storefront window, etc. In these types or kinds of applications, the EASL may be expanded or contracted to a desired width for adapting in any particular space that may be available depending on the application.

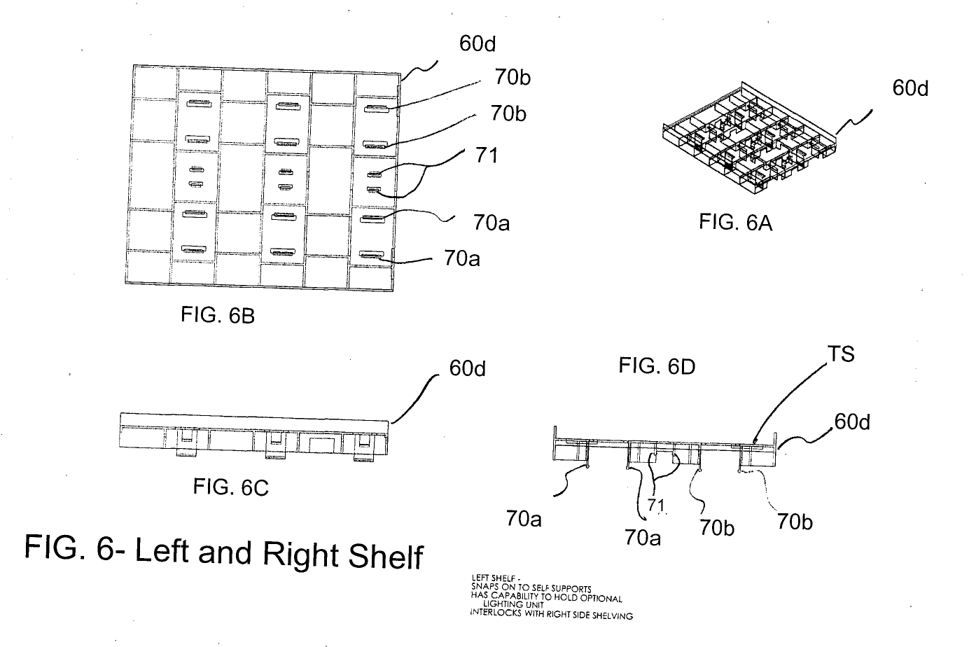

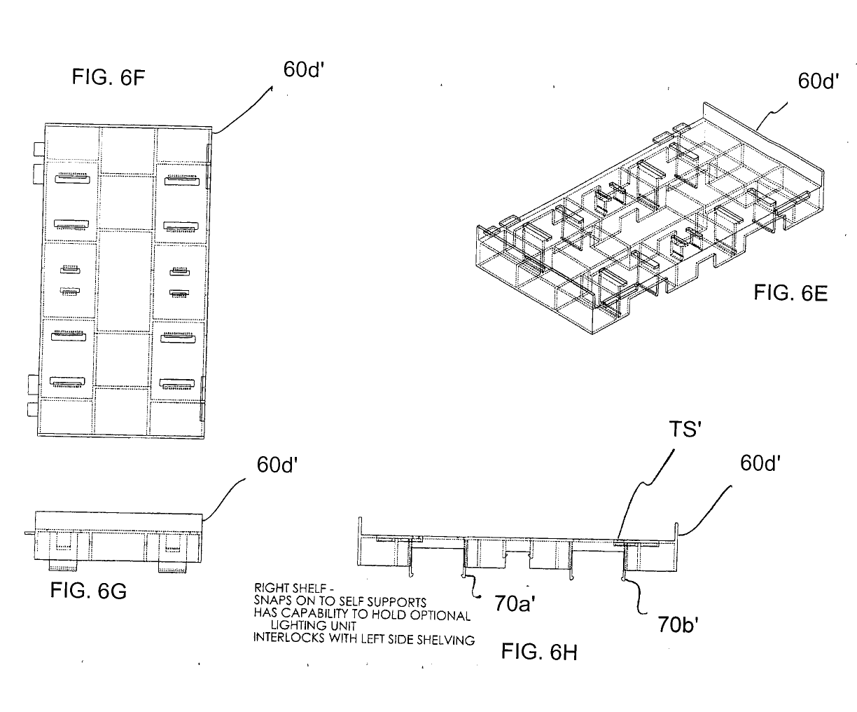

At least one intermediate or bottom shelf has one or more snap-on shelves 60d, 60d′ (see FIG. 6) configured with a top shelf surface TS, TS′ for receiving the product to be displayed and configured with lower flexible tabs 70a, 70b, 70a′, 70b′to frictionally engage the shelf leg 60b, the corresponding shelf leg 60U, or the combination thereof. The one or more snap-on shelves 60d, 60d′ may be configured with dimensions of about 6 inches, 12 inches or 18 inches so as to form the shelves having the predetermined widths of about 18 inches, 24 inches, 30 inches or 36 inches. The snap-on shelves 60, 60d may be configured to interlock with one another.

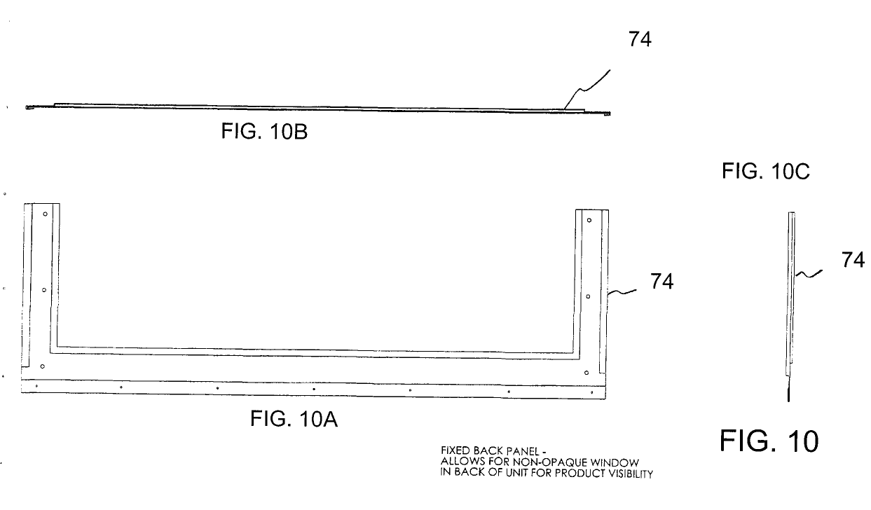

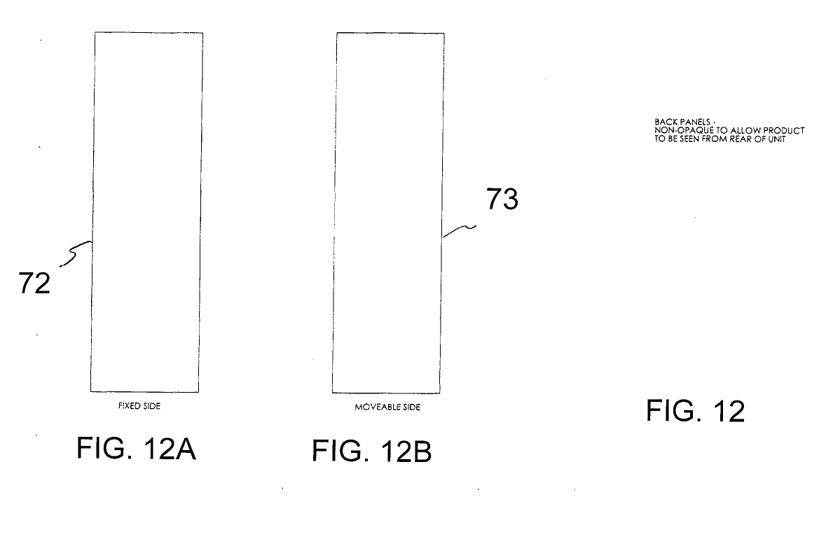

The EASL 12 has one or more back panels 72, 73 configured to affix onto one or more rigid metal side framing parts 74, 75, which is shown in more detail in FIGS. 10-12. As shown, the back panels may include a fixed panel 72 and a movable panel 73, see FIG. 12, for affixing respectively in the one or more rigid metal side framing parts 74, 75. The back panels allow for a non-opaque window in the back of the unit for product visibility.

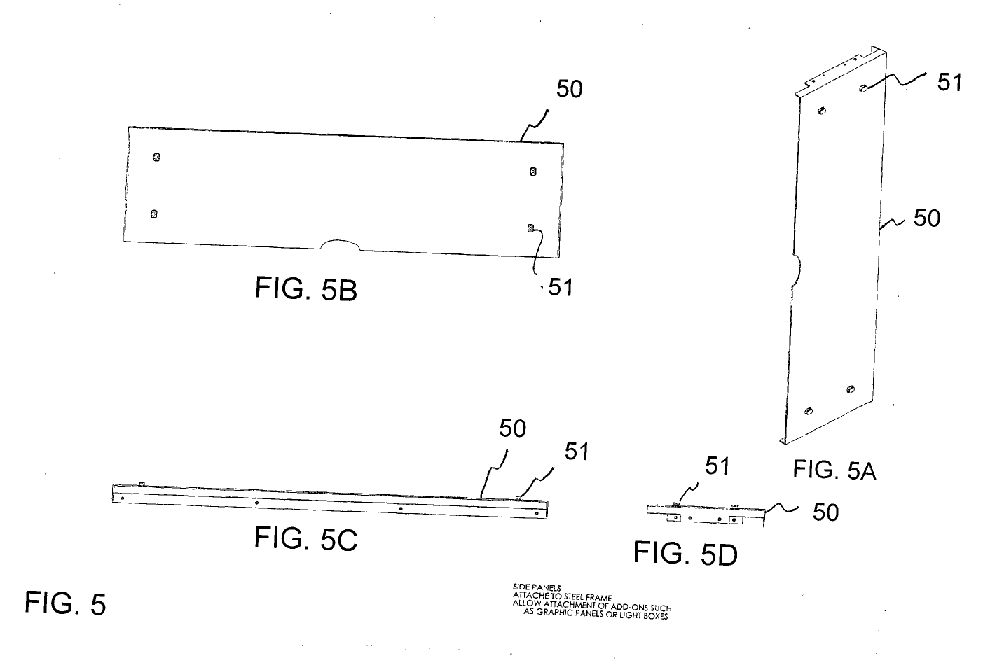

The EASL 12 has side panels 80, 82, each side panel configured to affix onto a respective rigid metal side framing part 50, 52, which are shown in more detail in FIG. 5.

In the EASL 12, the rigid metal side framing parts 50, 52 are configured with openings 50a to receive front and back stacking pins (not shown) for stacking merchandisers one on top of another.

The rigid metal side framing parts 50, 52 includes one or more tabs 50b to permanently mount the expandable, adjustable, stackable and lightable counter merchandiser 12 to a surface.

Each shelf 54, 56, 58, 60 may also include a joiner tube 60e configured for providing additional support in center bolts to side frame, which is shown in more detail in FIGS. 4c1, 4c2, 4c3.

The shelf support 60a, 60a′ may also include a cross member 60f coupled between the shelf legs 60b, 60b′.

The snap-on shelf 60d may also include lower flexible tabs 71 configured to hold undermount lighting unit (not shown) between the shelf legs 60b, 60b′ for lighting the product displayed inside the merchandiser 12.

The EASL may also include door panels 90, 92a, 92b a door locking arrangement 94, and associated door brackets and foldable hinging 96, 98a, 98b, 98c, 98d, 98e. The door panels 90, 92a, 92b may be configured to be foldable with associated door brackets and foldable hinging 96, 98a, 98b, 98c, 98d, 98e for folding and sliding into a space inbetween the side frames 50, 52 and the side panels 80, 82. In operation, the door panels 90, 92a, 92b are configured to show product fold, lock for security, and fold and tuck away between the side panels 80, 82 and the rigid metal side framing parts 50, 52.

Alternatively, the scope of the invention is also intended to include embodiments wherein the door panels 90, 92 are configured on standard hinges for swinging open and closed.

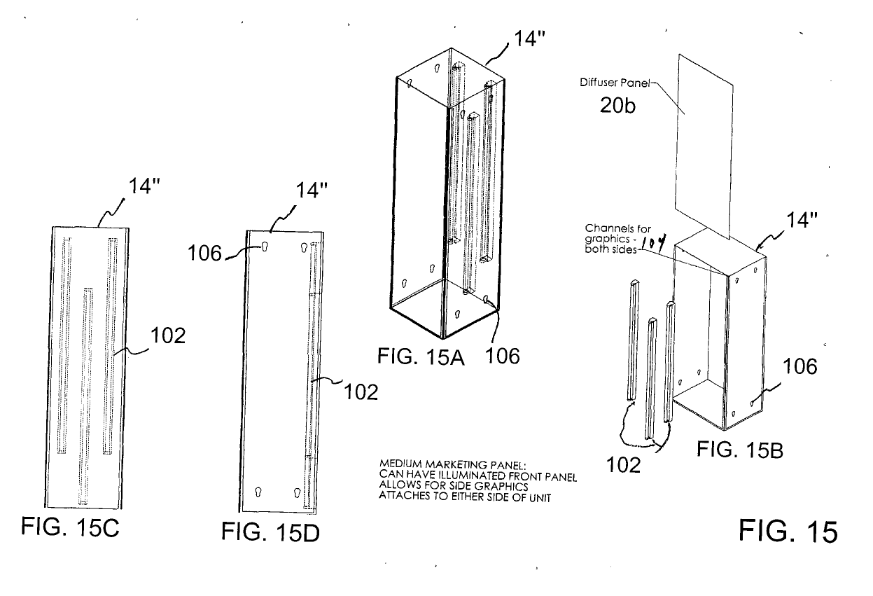

### FIGS. 13-16: The One or More Lighting Box 14

FIGS. 13-16 show the one or more lighting box 14 having a rigid frame 100 having six sides or walls so as to form a rectangular box with one or more lights 102 arranged therein. The frame 100 has channels for receiving graphics in the form a marketing board, consistent with that described above. The frame 100 also includes openings 106 for coupling to tabs 51 of the side panels 80, 82 (see FIG. 5) so as to hang the lighting box 14 on the side panel 80 or 82 of the EASL 12.

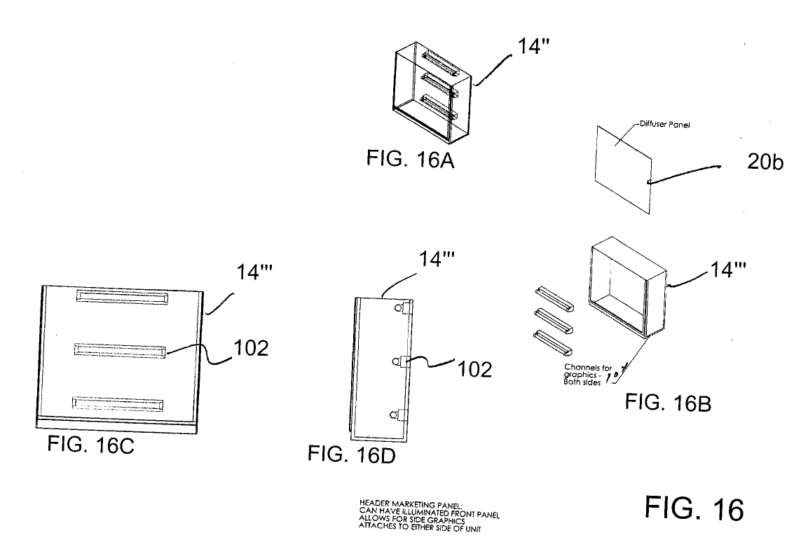

FIGS. 14-16 show other lighting boxes dimensioned slightly differently that the lighting box shown in FIG. 13. For example, FIG. 16 shows a lighting box 14′″ having channels for graphics on both sides of the box.

### Opaque or Acrylic Panels

The one or more of the side panels, the back panel, or the door panels may be non-opaque or acrylic depending on the application. The acrylic side panels, back panel, or door panels may also be colored to provided a visually dynamic glow, especially in darker environments.

### The Translucent Plastic Photochemical Receptive Substrate

Consistent with that described above, the translucent plastic photochemical receptive substrate 20a may be formulated using Duratran (graphic). However, the scope of the invention is intended to include using other types or kind of graphic media material that may be backlit either now known or later developed in the future.

### FIG. 17: Alternative Merchandiser 1700

FIG. 17 shows an alternative embodiment of the merchandiser generally indicated as 1700 according to some embodiments of the present invention, having a side support 1701, a 15 inch deep shelf support. 1702, 15 inch deep acrylic supports. 1703 and 1704, a cross brace 1705, a pan 1706, a rear corner post 1707, a rear acrylic 1708, a side acrylic 1709, a door acrylic 1710, a door hinge plate 1711, a piano hinge 1712, a cam lock 1713, an outwater D-lite 1714, a door hinge plate support 1715, a side acrylic brace 1716, a pan tab 1717 and an acrylic brace 1818.

### FIGS. 18 and 19

FIG. 18 shows an alternative embodiment of the cart generally indicated as 1800 according to some embodiments of the present invention, having solid doors 24a′, 24b′ and wheels 1802 configured on the bottom for rolling the cart 1800. As shown, the tray 26 is supported on one or more tray supports 27a.

In FIG. 19, the cart 1800 includes cart pans 1901, 1902, a cart frame 1903, a marketing board corner post 1904, a cart frame tube 1905, a cart back panel 1906, a cart back panel 1907, casters 1908, 1909, a piano hinge 1910, a side door panel 1911, a double door panel 1912, acrylic cart doors 1913, 1914, standoffs 1915, standoff caps 1916, a cart floor 1917, a cart shelf floor 1918, a cart shelf support 1919, a cart shelf support pivot 1920, a shelf tube 1921, a cart frame 1922 and a cam lock 1923.

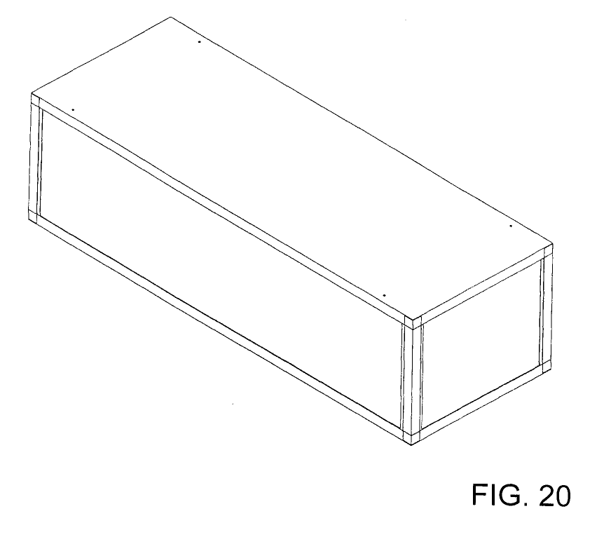

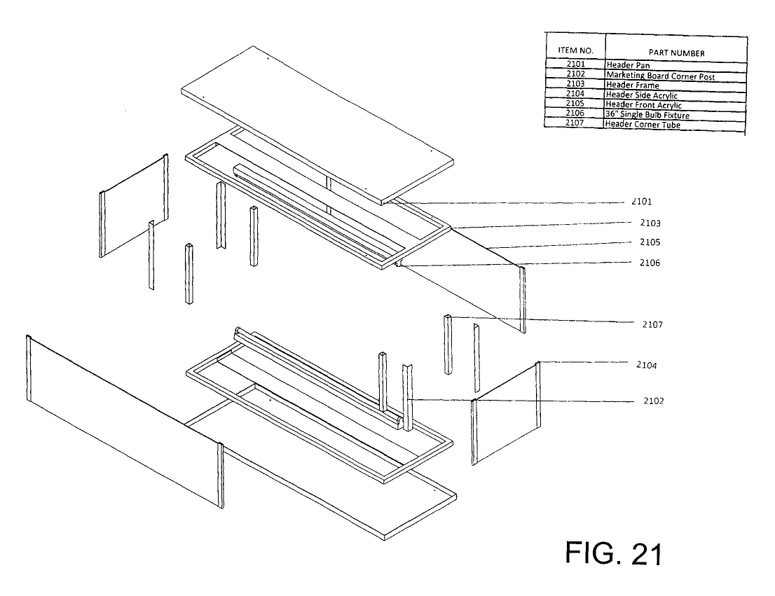

### FIGS. 20-21: Header Lightbox

FIG. 20-21 shows an alternative embodiment of a header lightbox generally indicated as 2000 according to some embodiments of the present invention.

In FIG. 21, the light box 200 includes a header pan 2001, a marketing board corner post 2002, a header frame 2003, an acrylic header side 2004, an acrylic header front 2005, a 36″ bulb fixture 2006 and a header corner tube 2007.

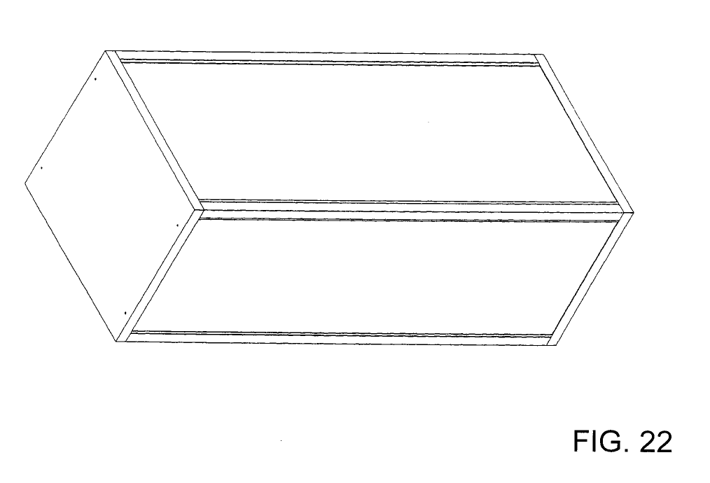

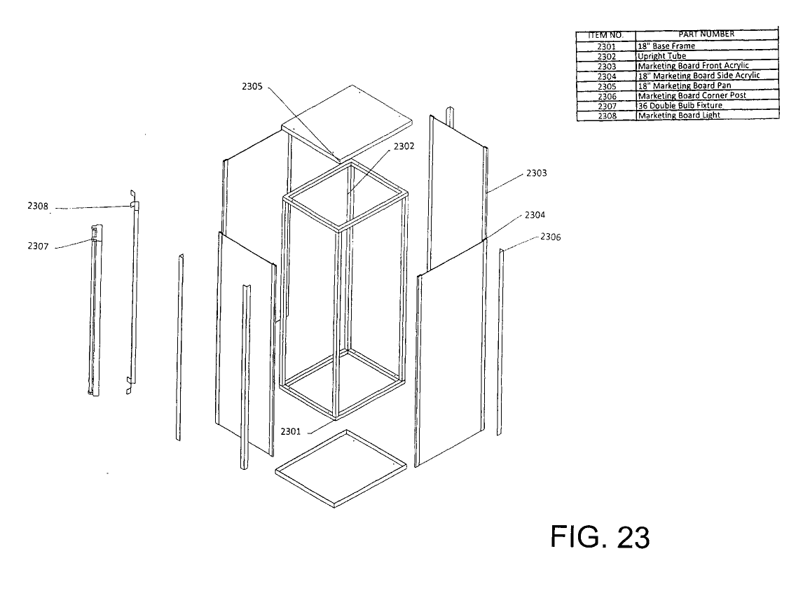

### FIGS. 22-23: Marketing Board Lightbox

FIG. 22-23 shows an alternative embodiment of a marketing board lightbox generally indicated as 2200 according to some embodiments of the present invention.

In FIG. 23, the light box 200 includes an 18″ base frame 2301, upright tubes 2302, a marketing board front acrylic 2303, an 18″ acrylic marketing board side acrylic 2304, an 18′ marketing board pan 2305, a marketing corner post pan 2306, a 36″ bulb fixture 2307 and a marketing board light support 2307.

### The Scope of the Invention

Although the units above are described as having various integral parts that are separately molded, or manufacturer, the scope of the invention is intended to include using other manufacturing techniques either now known or later developed in the future for providing the various integral parts.

The width, height or depth of the unit are provided by way of example, and the scope of the invention is not intended to be limited to any particular dimension of the width, height or depth of the unit.

It should also be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein without departing from the spirit and scope of the present invention.

1. A modular merchandiser for marketing a product, comprising:
a merchandiser configured with at least one shelf to display a product; and
a marketing lightbox configured to couple to the merchandiser, configured to receive a marketing board having a translucent plastic photochemical receptive substrate that is produced in a darkroom for receiving a graphic image through a digital printing process containing a message to market the product being displayed on the merchandiser, having a rigid transparent part or diffuser panel for providing support to the translucent plastic photochemical receptive substrate containing the message, and configured with one or more lights to provide backlit lighting through the marketing board so as to provide a backlit marketing message related to the product.

2. A modular merchandiser according to claim 1, wherein the translucent plastic photochemical receptive substrate is covered with a thin piece of clear acrylic to provide protection.

3. A modular merchandiser according to claim 1, wherein the merchandiser and the marketing lightbox are coupled along one side having substantially the same length so as to provide a modular design.

4. A modular merchandiser according to claim 1, wherein the modular merchandiser further comprises a second marketing lightbox configured to detachably couple to the top of the merchandiser and the marketing lightbox so as to provide a modular design.

5. A modular merchandiser according to claim 1, wherein the modular merchandiser further comprises a cart configured to support the merchandiser and the marketing lightbox.

6. A modular merchandiser according to claim 1, wherein the cart is configured to roll.

7. A modular merchandiser according to claim 6, wherein the cart is configured with a tasting tray for supporting the alcoholic product and glassware for tasting.

8. A modular merchandiser according to claim 6, wherein the merchandiser is an expandable, adjustable, stackable and lightable counter merchandiser, comprising:
rigid metal side framing parts;
at least three adjustable shelf supports coupled between the rigid metal side framing parts so as to form shelves, including at least a top shelf, a bottom shelf and an intermediate shelf;
each rigid metal side framing part having multiple front and rear holes for providing multiple shelf mounting locations;
each shelf support having a shelf mounting member configured to couple to a set of the multiple front and rear holes of the rigid metal side framing parts for mounting shelf support between the rigid metal side framing parts;
each shelf support having at least one shelf leg member with multiple holes for providing width adjustment;
at least one shelf leg member having an elongated rectangular shape configured with a hollow cavity portion;
at least one corresponding shelf leg member having a corresponding elongated rectangular shape configured to slide within the hollow cavity portion of the at least one shelf leg member for providing width adjustment.

9. A modular merchandiser according to claim 7, wherein the rigid metal side framing parts comprises a rigid metal left side framing part including:
a left side frame having multiple left side front and rear holes for providing multiple shelf mounting locations, and
a left side shelf support having a shelf mounting member configured to couple to a set of the multiple left side front and rear holes of the left side frame for mounting the left side shelf support to the left side frame at one of the left side multiple shelf mounting locations, and having at least one left side shelf leg member with multiple holes for providing width adjustment, the at least one left side shelf leg member having an elongated rectangular shape configured with a hollow cavity portion; and
the rigid metal side framing parts comprises a rigid metal right side framing part including:
a right side frame having multiple right side front and rear holes for providing multiple shelf mounting locations, and
a right side shelf support having a shelf mounting member configured to couple to a set of the multiple right side front and rear holes of the right side frame for mounting the right side shelf support to the right side frame at one of the multiple right side shelf mounting locations, and having at least one right side shelf leg member with multiple holes for providing width adjustment, the at least one right side shelf leg member having a corresponding elongated rectangular shape configured to slide within the hollow cavity portion of the at least one left side shelf leg member; and
the left side framing part and the right side framing part configured to slide in relation to one another so as to expand and contract to various widths depending on a particular application.

10. A modular merchandiser according to claim 7, wherein the modular merchandiser comprises
side frame tabs to permanently mount the expandable, adjustable, stackable and lightable counter merchandiser to a surface; and
a joiner tube for providing additional support in center bolts to side frame.

11. An expandable, adjustable, stackable and lightable counter merchandiser, comprising:
rigid metal side framing parts;
at least three adjustable shelf supports coupled between the rigid metal side framing parts so as to form shelves, including at least a top shelf, a bottom shelf and at least one intermediate shelf;
each rigid metal side framing part having multiple front and rear holes configured for providing multiple shelf mounting locations;
each shelf having a shelf support with a shelf mounting member configured to couple to a set of the multiple front and rear holes of the rigid metal side framing parts for mounting the shelf support between the rigid metal side framing parts;
each shelf support having shelf legs with multiple holes configured for providing width adjustment;
each shelf support including a shelf leg having an elongated rectangular shape configured with a top surface and two side surfaces so as to form a hollow underneath portion;
each shelf support including a corresponding shelf leg having a corresponding elongated rectangular shape configured with a bottom surface and two corresponding side surfaces and dimensioned to slide within the hollow underneath portion of the shelf leg for providing the width adjustment by aligning corresponding multiple holes of shelf supports and securing the corresponding multiple holes with fasteners;
at least one intermediate or bottom shelf having one or more snap-on shelves configured with a top shelf surface for receiving product to be displayed and configured with lower flexible tabs to frictionally engage the shelf leg, the corresponding shelf leg or the combination thereof;
a back panel configured to affix onto the rigid metal side framing parts;
side panels, each side panel configured to affix onto a respective rigid metal side framing part; and
the rigid metal side framing parts configured to receive front and back stacking pins for stacking merchandisers one on top of another.

12. An expandable, adjustable, stackable and lightable counter merchandiser according to claim 11, wherein the rigid metal side framing parts side frame includes one or more tabs to permanently mount the expandable, adjustable, stackable and lightable counter merchandiser to a surface.

13. An expandable, adjustable, stackable and lightable counter merchandiser according to claim 11, wherein each shelf includes a joiner tube configured for providing additional support in center bolts to side frame.

14. An expandable, adjustable, stackable and lightable counter merchandiser according to claim 11, wherein the shelf support includes a cross member coupled between the shelf legs.

15. An expandable, adjustable, stackable and lightable counter merchandiser according to claim 11, wherein the snap-on shelf includes lower flexible tabs configured to hold undermount lighting unit between the shelf legs.

16. An expandable, adjustable, stackable and lightable counter merchandiser according to claim 11, wherein one or more of the side panels, the back panel or the door panels is non-opaque.

17. An expandable, adjustable, stackable and lightable counter merchandiser according to claim 11, wherein one or more of the side panels, the back panel or the door panels is acrylic.

18. An expandable, adjustable, stackable and lightable counter merchandiser according to claim 11, wherein one or more of the side panels is configured with a graphic image for advertising a product.

19. An expandable, adjustable, stackable and lightable counter merchandiser according to claim 11, wherein the multiple holes of the shelf legs are configured for providing width adjustment at predetermined widths of about 18 inches, 24 inches, 30 inches or 36 inches.

20. An expandable, adjustable, stackable and lightable counter merchandiser according to claim 11, wherein the one or more snap-on shelves are configured with dimensions of about 6 inches, 12 inches or 18 inches so as to form the shelves having the predetermined widths of about 18 inches, 24 inches, 30 inches or 36 inches.

21. An expandable, adjustable, stackable and lightable counter merchandiser according to claim 11, wherein the shelf mounting member configured to couple to the set of the multiple front and rear holes of the rigid metal side framing parts using a bolting configuration.

22. An expandable, adjustable, stackable and lightable counter merchandiser according to claim 11, wherein the one or more snap-on shelves includes a left snap-on shelf and a right snap-on shelf.

23. An expandable, adjustable, stackable and lightable counter merchandiser according to claim 22, wherein the left snap-on shelf and the right snap-on shelf are configured to interlock with one another.

24. An expandable, adjustable, stackable and lightable counter merchandiser according to claim 11, wherein the door panels configured with door brackets.

25. An expandable, adjustable, stackable and lightable counter merchandiser according to claim 11, wherein one or both of the side panels include a marketing board or panel configured with lighting arranged therein and a diffuser panel for providing an illuminated diffuser panel for marketing a product.

26. An expandable, adjustable, stackable and lightable counter merchandiser according to claim 11, wherein the marketing board or panel is configured with channels for slidably receiving the diffuser panel.

27. An expandable, adjustable, stackable and lightable counter merchandiser according to claim 11, wherein the expandable, adjustable, stackable and lightable counter merchandiser comprises door panels configured to show product fold, lock for security, and fold and tuck away between the side panels and the rigid metal side framing parts.

28. An expandable, adjustable, stackable and lightable counter merchandiser, comprising:
rigid metal side framing parts;
at least three adjustable shelf supports coupled between the rigid metal side framing parts so as to form shelves, including at least a top shelf, a bottom shelf and at least one intermediate shelf;
each rigid metal side framing part having multiple front and rear holes configured for providing multiple shelf mounting locations;
each shelf having a shelf support with a shelf mounting member configured to couple to a set of the multiple front and rear holes of the rigid metal side framing parts for mounting the shelf support between the rigid metal side framing parts;
each shelf support having shelf legs with multiple holes configured for providing width adjustment;
each shelf support including a shelf leg having an elongated rectangular shape configured with a top surface and two side surfaces so as to form a hollow underneath portion;
each shelf support including a corresponding shelf leg having a corresponding elongated rectangular shape configured with a bottom surface and two corresponding side surfaces and dimensioned to slide within the hollow underneath portion of the shelf leg for providing the width adjustment by aligning corresponding multiple holes of shelf supports and securing the corresponding multiple holes with fasteners;
at least one intermediate or bottom shelf having one or more snap-on shelves configured with a top shelf surface for receiving product to be displayed and configured with lower flexible tabs to frictionally engage the shelf leg, the corresponding shelf leg or the combination thereof;
a back panel configured to affix onto the rigid metal side framing parts;
side panels, each side panel configured to affix onto a respective rigid metal side framing part;
door panels configured to show product fold, lock for security, and fold and tuck away between the side panels and the rigid metal side framing parts; and
the rigid metal side framing parts configured to receive front and back stacking pins for stacking merchandisers one on top of another.
